(19) United States
(12) Patent Application Publication
(10) Pub. No.: US 2010/0262497 A1
(43) Pub. Date: Oct. 14, 2010

(54) Systems and methods for controlling bidding for online advertising campaigns

(76) Inventor: Niklas Karlsson, Mountain View, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/385,552

(22) Filed: Apr. 10, 2009

(51) Int. Cl. G06Q 30/00; G06N 5/02

(52) U.S. Cl. 705/14.71; 706/52; 705/26

(57) ABSTRACT

A system is provided for managing bid prices of an online advertising campaign. The system includes a memory storing instructions for adjusting bid prices, and a campaign controller for generating a nominal bid price and a perturbation parameter, based on an ad request received from an advertiser. The system further includes a perturbation engine for generating a perturbed bid price based on the nominal bid price and the perturbation parameter, according to the instructions stored in the memory. The system further includes a serving unit for serving an ad impression based on the perturbed bid price. A computer-implemented method for managing bid prices of an online advertising campaign is also provided.

### TECHNICAL FIELD

The embodiments described below relate generally to systems and methods for managing online advertising campaigns, and more specifically, to systems and methods for managing bid prices in online advertising campaigns.

### BACKGROUND

Online advertising campaigns typically involve delivering numerous advertisements across the Internet for placement on websites during a specified period of time. These advertisements may be displayed as “banner ads” on various websites. For example, a company may design several advertisements for a new product, and may wish to have the advertisements placed during the period of time surrounding the launch of the new product. Each time one of the advertisements is shown to a user is known as an “impression.” When shown the advertisement, the user may select, or “click,” on the advertisement or may take another “action” such as completing an online form to request more information. If the user later purchases the new product, the purchase is referred to as a “conversion” of the impression.

Advertisers may be interested in impressions (e.g., if they are trying to increase awareness of a brand), clicks (e.g., if they are trying to provide more information about a product), or conversions (e.g., if they are trying to make sales or get new users to sign up for services). Advertisers may pay based on, for example, impressions, clicks, or conversions over the course of an advertising campaign. An advertiser may have a spending plan that specifies how the advertiser wishes to spend its budget during a campaign. For example, the advertiser may wish to spend money only on certain days during the campaign, or may wish to spend evenly over every day of the campaign. Each advertiser may have a daily budget (e.g., $1,000 per day) and/or a daily goal of impression volume (e.g., 1000 impressions per day), known as “daily delivery” or “pacing.”

As a result, various techniques are used to manage online ad delivery within and among advertising campaigns. In certain advertising networks, ad servers receive impression requests from publishers (e.g., websites or other entities with an inventory of online ad space). The ad servers may group ad requests from various advertising campaigns, e.g., according to impressions to be “targeted” based on a combination of attributes defined by the ad requests. In addition to targeting requirements, each ad request received from an advertiser generally includes a “bid price” and possibly a “bid allocation”. The bid price is the amount of money offered by the ad request for placement of the targeted impression. The bid allocation, if present, is the ratio (e.g., point value from 0 to 1) of targeted inventory the ad campaign is willing to purchase at the bid price. The list of ads that target a certain impression request may be sorted in descending order according to their bid price, and then placed in groups such that the sum of their bid allocations equals 1. If the ad request with the highest bid price has a bid allocation of 1, or if the bid allocation does not exist, it will always win the impression. Such ad delivery methods ensure that the advertiser with an ad with the greatest expected value is able to purchase as much inventory as desired. These methods also reveal both the marginal value of the impression inventory (e.g., the cost required per impression), and the amount of volume (e.g., the number of impressions) purchased at each price. Under stable campaign operating conditions, the information can be used to analyze the relationship between bid price and impression volume. For example, an advertiser could construct a price-volume curve to determine the bid price needed to purchase a desired volume of ad inventory, within a daily budget.

This type of competitive marketplace may become problematic, however, when the price-volume curve is not smooth and fixed, and is therefore unpredictable. For example, in a decentralized network (i.e., without knowledge of competing advertisers' bid prices and targeting preferences), if three separate advertisers are bidding at three separate bid prices, it may be difficult for a fourth advertiser to select a bid price relative to the other three bid prices, that results in a desired volume of delivered impressions for the fourth advertiser. This might occur when the highest bidding advertiser is typically awarded all of the impressions, subject to any bid allocation parameters. If the highest bidding advertiser withdraws from the marketplace, the next highest bidding advertiser will suddenly be awarded the impressions that would otherwise have been awarded to the withdrawn advertiser. This may cause the second highest bidding advertiser to be awarded too many impressions for its daily budget constraints, and therefore to withdraw from the marketplace. Consequently, the third highest bidding advertiser may suddenly be awarded the impressions that would otherwise have been awarded to the withdrawn second highest bidder, and so on. Such sudden shifts in the marketplace may increase the risk of over-delivering ad impressions to bidding advertisers, causing them to exceed their daily budgets, daily impression goals, etc.

In another example, when the highest bidding advertiser of the moment generally wins the majority of the impressions, lower bidding advertisers may be unable to adjust their bid prices to obtain a desired volume of impressions. For example, if a large competing advertising campaign is bidding at $1.00 per impression, and a second campaign cannot bid above $1.00 without exceeding its daily campaign budget, the second campaign may be forced to bid below the large competing advertising campaign, and therefore to under-deliver (e.g., to fall below its desired volume of ad impressions). Even if the second campaign increases its bid price, as long as it bids below $1.00, its delivery volume will not adjust accordingly because the larger campaign will continue to win its $1.00 bids, until it is withdrawn or out-bid by another campaign, causing marketplace instability.

Because of system delays inherent in online advertising networks, it is often difficult to predict or establish campaign parameters to start and stop ad campaigns based on real-time metrics of ad delivery. In addition, the exact bid price of a competing campaign may vary over time, so it cannot be relied upon for purposes of predicting volume. Therefore, the use of decentralized feedback to bid above or below a competing campaign's bid price is severely limited by slow response time and unpredictability of competing advertising campaigns. These characteristics of a competitive advertising marketplace may be undesirable to advertising customers that desire for their ads to be delivered smoothly over the course of the ad campaign, according to pre-defined daily spending budgets and/or impression volume delivery goals.

The present disclosure is directed to solving one or more of the above-mentioned challenges by improving the controllability of advertising campaigns in a competitive advertising marketplace when using the bid price as a control lever.

### SUMMARY

In accordance with one disclosed exemplary embodiment, a system is provided for managing bid prices of an online advertising campaign. The system includes a memory storing instructions for adjusting bid prices, and a campaign controller for generating a nominal bid price and a perturbation parameter, based on an ad request received from an advertiser. The system further includes an engine for generating a perturbed bid price based on the nominal bid price and the perturbation parameter, according to the instructions stored in the memory. The system further includes a serving unit for serving an ad impression based on the perturbed bid price.

In accordance with another disclosed exemplary embodiment, a computer-implemented method is provided for managing bid prices of an online advertising campaign. The method includes storing instructions for adjusting bid prices in a memory, receiving an ad request from an advertiser, and generating a nominal bid price and a perturbation parameter, based on the ad request. The method further includes generating a perturbed bid price based on the nominal bid price and the perturbation parameter, according to instructions stored in the memory. The method further includes serving an ad impression for the ad request based on the perturbed bid price.

In accordance with another disclosed exemplary embodiment, a computer-readable storage medium is provided for storing a computer program which, when executed by a computer, causes the computer to perform a method. The method includes the steps of storing instructions for adjusting bid prices in a memory; receiving an ad request from an advertiser; and generating a nominal bid price and a perturbation parameter, based on the ad request. The method also includes the steps of generating a perturbed bid price based on the nominal bid price and the perturbation parameter, according to the instructions stored in the memory; and serving an ad impression for the ad request based on the perturbed bid price.

### BRIEF DESCRIPTION OF THE DRAWINGS

FIG. 1 depicts a block diagram of an exemplary system on which online advertising campaigns may be managed, consistent with embodiments of the present disclosure;

FIG. 2 depicts a flow chart of an exemplary method for managing bid prices of online advertising campaigns, consistent with embodiments of the present disclosure;

FIG. 3 depicts a block diagram of an exemplary system for managing bid prices of online advertising campaigns, consistent with embodiments of the present disclosure;

FIG. 4A illustrates a graphical representation of a bid distribution for three exemplary conventional advertising campaigns;

FIG. 4B illustrates a graphical representation of a price-volume relationship for three exemplary conventional advertising campaigns;

FIG. 5A illustrates a graphical representation of a bid distribution for three exemplary advertising campaigns using bidding methods consistent with embodiments of the present invention;

FIG. 5B illustrates a graphical representation of a price-volume relationship for three exemplary advertising campaigns using bidding methods consistent with embodiments of the present invention;

FIG. 6A illustrates a graphical representation of a bid distribution for three exemplary advertising campaigns using three exemplary perturbation parameters; and

FIG. 6B illustrates a graphical representation of a price-volume relationship for three exemplary advertising campaigns using three exemplary perturbation parameters.

### DETAILED DESCRIPTION OF THE DRAWINGS

Reference will now be made in detail to exemplary embodiments of the invention, examples of which are illustrated in the accompanying drawings. Wherever possible, the same reference numbers will be used throughout the drawings to refer to the same or like parts.

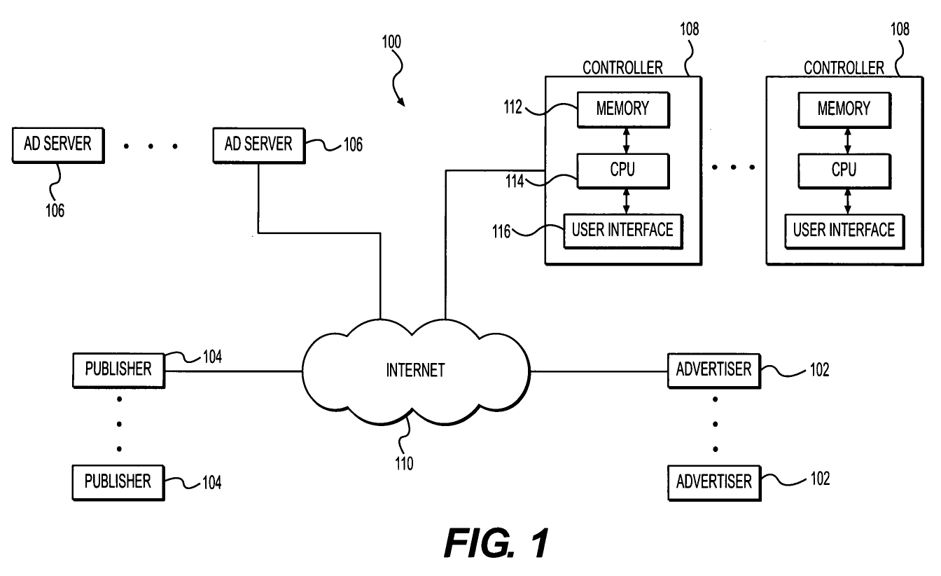

FIG. 1 illustrates an exemplary system 100 for controlling online advertising campaigns. System 100 may include a plurality of advertisers 102, publishers 104, ad servers 106, and controllers 108, in communication with the Internet 110. Advertisers 102 may include any entities having online advertisements (e.g., banner ads, pop-ups, etc.) desired to be delivered to online users. Advertisers 102 may interact with publishers 104, ad servers 106, and/or controllers 108 through computers connected to the Internet 110. Thus, advertisers 102 may be able to communicate advertising information, such as ad information, targeting information, consumer information, budget information, bidding information, etc., to other entities in system 100.

Publishers 104 may include any entities having inventories of available online advertising space. For example, publishers 104 may include online content providers, search engines, e-mail programs, or any entity or program having online user traffic. Publishers 104 may interact with advertisers 102, ad servers 106, and/or controllers 108 via computers connected to the Internet 110. Thus, publishers 104 may be able to communicate inventory information, such as site information, demographic information, cost information, etc., to other entities in system 100.

Ad servers 106 may include any type of servers configured to process advertising information from advertisers 102 and/or inventory information from publishers 104, either directly or indirectly. In certain embodiments, ad servers 106 may be remote web servers that receive advertising information from advertisers 102 and serve ads to be placed by publishers 104. Ad servers 106 may be configured to serve ads across various domains of publishers 104, for example, based on advertising information provided by advertisers 102. Ad servers 106 may also be configured to serve ads based on contextual targeting of web sites, search results, and/or user profile information. In some embodiments, ad servers 106 may be configured to serve ads based on control signals generated by controllers 108.

Controllers 108 may include one or more computing systems configured to receive information from entities in system 100, process the information, and generate control signals to be sent to entities in system 100, according to methods described herein. Controllers 108 may include any type or combination of computing systems, such as clustered computing machines and/or servers. In one embodiment, each controller 108 may be an assembly of hardware, including a memory 112, a central processing unit (“CPU”) 114, and/or a user interface 116. Memory 112 may include any type of RAM or ROM embodied in a physical storage medium, such as magnetic storage including floppy disk, hard disk, or magnetic tape; semiconductor storage such as solid state disk (SSD) or flash memory; optical disc storage; or magneto-optical disc storage. CPU 114 may include one or more processors for processing data according to instructions stored in the memory. The functions of the processor may be provided by a single dedicated processor or by a plurality of processors. Moreover, the processor may include, without limitation, digital signal processor (DSP) hardware, or any other hardware capable of executing software. User interface 116 may include any type or combination of input/output devices, such as a display monitor, keyboard, and/or mouse.

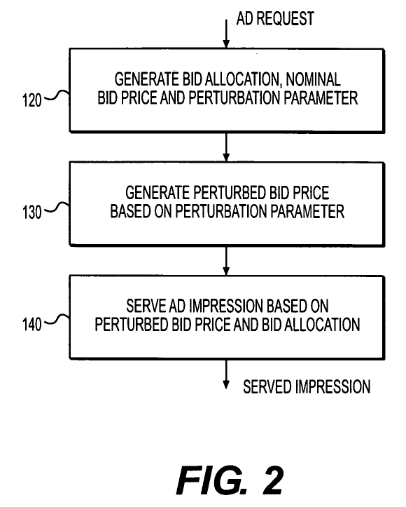

FIG. 2 illustrates an exemplary method for managing bid prices of an online advertising campaign operating in system 100. In general, when an ad request is received, e.g., from a publisher, system 100 may generate a bid allocation, a nominal bid price, and/or a perturbation parameter for the ad request (Step 120). Therefore, unlike a traditional bid request having only a bid price and possibly a bid allocation, methods consistent with the present invention may generate a perturbation parameter corresponding to the initial ad request. Moreover, unlike traditional bid requests in which the bid price alone defines the value of the bid, system 100 may generate a nominal bid price, which is used to calculate a final value of the bid, based on the perturbation parameter.

The terms “perturb” and “perturbation” are used herein to describe any aspect of slightly changing or adjusting a value. For example, a perturbation parameter may be any secondary influence on a value that causes it to deviate slightly. A perturbation may also be considered to be a “disturbance” in an otherwise constant value. In certain embodiments, the perturbation process is described as involving “uncertainty,” in recognition of Heisenberg's “uncertainty principle.” This uncertainty may relate to the parameter used to perturb the bid prices and/or the overall uncertainty associated with embodiments in which the bid prices are perturbed randomly.

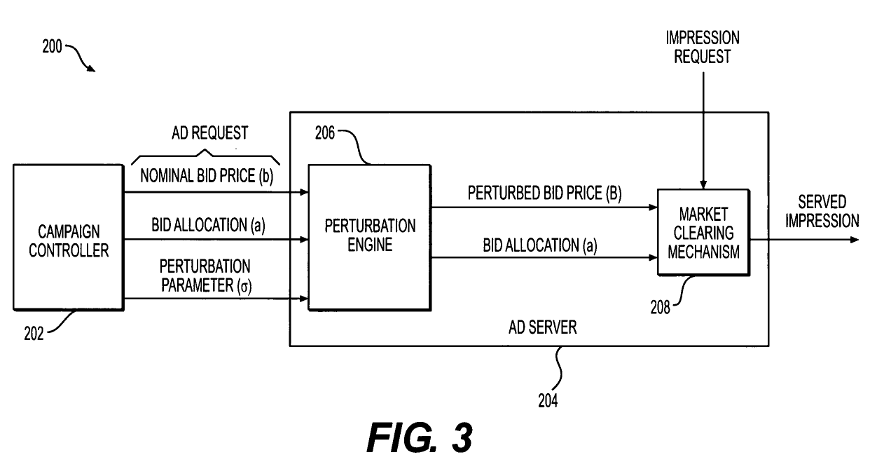

As with other competitive advertising bidding networks, the systems and methods described herein may generally involve generating a bid price for each ad request, or generating a bid price and a bid allocation for each ad request. In the exemplary embodiments described herein and depicted in FIGS. 2 and 3, the systems and methods are described as generating this optional bid allocation in addition to the bid price, for each ad request. However, it will be appreciated that the bid allocation may be generated only for certain ad requests, or it may be omitted from all ad requests, in which case the present systems and methods may still generate a nominal bid price and a perturbation parameter.

Thus, system 100 may be configured to generate a perturbed bid price based on the nominal bid price and perturbation parameter (Step 130). As will be described in more detail below, the perturbation parameter may be a variable or preset parameter used to adjust the nominal bid price into a perturbed bid price. For example, the perturbation process may involve additive, multiplicative, or any other types of operations designed to perturb a bid price value. Other types of perturbation may be used to form a distribution of bid prices varying around a desired nominal bid price. As will be described in more detail below, in one embodiment, a Gamma distribution may be used to perturb the nominal bid price. Thus, the exemplary systems and methods described herein may involve perturbing the bid prices of numerous ad requests generated for an advertising campaign, based on a perturbation parameter value and/or other user-defined parameters. Finally, the method may include serving an ad impression based on the perturbed bid price and, optionally, a bid allocation (Step 140). Because the bid price of each ad request may be independently perturbed, numerous ad requests may be processed by an ad server based on numerous slightly varying perturbed bid prices.

FIG. 3 illustrates a block diagram of an exemplary control system 200 for controlling bid prices of online advertising campaigns. Control system 200 may be implemented by one or more of advertisers 102, publishers 104, ad servers 106, and/or controllers 108. In one embodiment, control system 200 may include a campaign controller 202 and an ad server 204. Campaign controller 202 and ad server 204 may be computers connected to the Internet, as described with respect to ad servers 106 and controllers 108 of system 100. Alternatively, campaign controller 202 and ad server 204 may be software modules executed by CPUs 114 of controllers 108 and/or ad servers 106.

As depicted in the embodiment of FIG. 3, campaign controller 202 may be configured to generate an ad request, including a nominal bid price (b), a bid allocation (a), and a perturbation parameter (a). Again, it will be appreciated that bid allocation (a) is optional, and may be omitted from one or more ad requests. Moreover, as described above, unlike a traditional bid request having only a bid price and possibly a bid allocation, campaign controller 202 may generate a perturbation parameter (σ) for the initial ad request. Moreover, unlike traditional bid requests in which the bid price alone defines the value of the bid, the method may include generating a nominal bid price (b), which is used to calculate a final value of the bid. The ad request may be received by a perturbation engine 206 implemented by ad server 204. Alternatively, only the nominal bid price (b) and perturbation parameter (σ) may be received by perturbation engine 206, while the bid allocation (a) is stored by ad server 204.

Perturbation engine 206 may be configured to generate a perturbed bid price (B) based on the nominal bid price (b) and perturbation parameter (σ). Perturbation engine 206 may implement any suitable type or combination of random and/or deterministic perturbation functions. In one exemplary embodiment of the disclosure, perturbation engine 206 may be configured to implement a Gamma distribution to perturb the nominal bid price (b) into the perturbed bid price (B), based on the perturbation parameter (σ). Perturbation engine 206 may then send the perturbed bid price (B) and the bid allocation (a) to a market clearing mechanism 208 implemented by ad server 204. In certain embodiments, the final, perturbed bid price (B) implemented by market clearing mechanism 208 may be a function of one or more of the perturbation parameter, the nominal bid price, the bid allocation (if applicable), the time, the ad server, the ad network, etc. Market clearing mechanism 208 may be a competitive advertising marketplace mechanism that matches ad requests and impression requests in a decentralized and efficient manner. Thus, market clearing mechanism 208 may serve ad impressions based on the perturbed bid price (B) and/or bid allocation (a) of each ad request.

One exemplary method for perturbing bid prices will now be described in detail. However, it will be appreciated by those of skill in the art that various numerical methods may be used for perturbing the bid price consistent with the systems and methods described and claimed herein. In one embodiment, a Gamma distribution may be used as a probability model for creating a distribution of perturbed bid prices. A Gamma distribution may include two parameters: shape (α) and scale (β). In one embodiment, if a given variable, x, is Gamma distributed, its probability density function (pdf) may be defined as follows:

$$pdf ( x \vert α , β ) = \frac{1}{{β}^{α} Γ ( α )} {x}^{α - 1} {e}^{- x / β}$$

In such a distribution, it may be shown that the expected value E(x) and standard deviation Std(x) of the distributed variable may be defined as follows:

E(x)=αβ and Std(x)=\sqrt{αβ²}

As a result, the shape (α) and scale (β) used by the Gamma distribution may be set as follows: α=1/σ² and β=bσ², such that:

E(B)=(1/σ²)bσ²=b

Std(B)=\sqrt{1/σ²(bσ²)²}=bσ

Thus, in order to obtain each perturbed bid value, B, perturbation engine 206 may operate a Gamma distribution, given a nominal bid price, b, and perturbation parameter, σ, where:

B˜Gamma(1/σ²,bσ²).

One exemplary method for obtaining a perturbed bid value, B, is depicted in the following exemplary table in which three advertising campaigns or “media” are bidding using a perturbation parameter value, σ, of 0.05.

| | Bid | Bid | Perturbation | |
|---|---|---|---|---|
| | Price | Allocation | parameter | Final “Perturbed” Bid |
| Media 3 | b = $2 | a = 0.4 | σ = 0.05 | B₃~Gamma(400, 0.005) |
| Media 2 | b = $1 | a = 0.4 | σ = 0.05 | B₂~Gamma(400, 0.0025) |
| Media 1 | b = | a = 0.2 | σ = 0.05 | B₁~Gamma(400, 0.0013) |
| | $0.50 | | | |

In one exemplary embodiment, in order to obtain each perturbed bid price, B, the following process may be used for each bid request. If perturbation parameter, σ=0, or if nominal bid price, b≦0, set perturbed bid price, B=b. Otherwise determine:

$$B = {b ( σ )}^{2} G ( \frac{1}{{( σ )}^{2}} )$$

where b is the nominal bid price value submitted to the ad servers, where σ is the perturbation parameter, where

$$G ( \frac{1}{{( σ )}^{2}} ) = G ( α ) ,$$

and where G(α) is the Gamma random number function defined as follows.

In this exemplary embodiment, in order to find G(α), the following calculations may be formed in the order indicated below:

$$1. Set N = \{ \begin{matrix}\frac{1}{α} & α \leq 0.4 \\ \frac{1}{α} + \frac{α - 0.4}{3.6 α} & 0.4 < α \leq 4 \\ \frac{1}{\sqrt{α}} & α > 4\end{matrix} \\ 2. Set {b}_{1} = α - \frac{1}{N} and {b}_{2} = α + \frac{1}{N} \\ 3. Set {c}_{1} = \{ \begin{matrix}0 & α \leq 0.4 \\ {b}_{1} \frac{ln {b}_{1} - 1}{2} & α > 0.4\end{matrix} \\ and {c}_{2} = {b}_{2} \frac{ln {b}_{2} - 1}{2}$$

4. Generate two independent random values R₁ and R₂, both selected from a uniform distribution on (0,1).

5. Set w₁=c₁+ln R₁, w₂=c₂+ln R₂, and y=N(b₁w₂−b₂w₁)

6. If y<0, go to step 4

7. Set x=N(w₂−w₁)

8. If ln y<x, go to step 4

9. Return the value G(α)=e^{x}

Thus, the exemplary systems and methods described herein may be configured to create a Gamma distribution of perturbed bid prices, B, surrounding a nominal bid price, b, for the campaign, instead of numerous bid prices all having the same value. In other words, some of the perturbed bid prices B will be above the nominal bid price and competing bid prices, and some of the perturbed bid prices B will be below the nominal bid price and competing bids. This may result in a smooth relationship between nominal bid price and awarded impression volume for a campaign. In other words, because the price-volume curve may be smoothed by numerous varying bid prices, there may be a nominal bid value that results in a desired volume of impression delivery, as will be illustrated below.

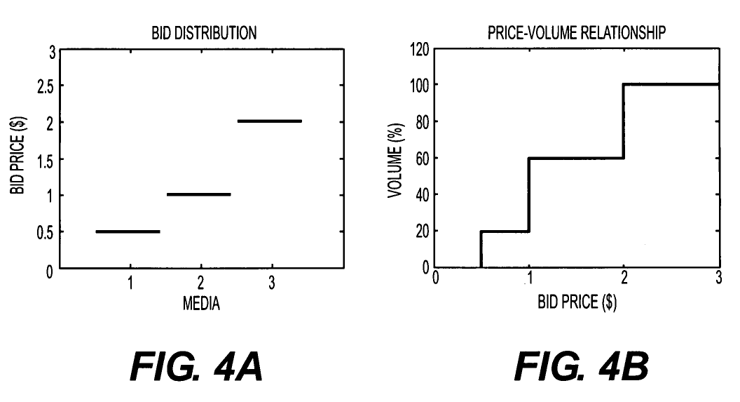

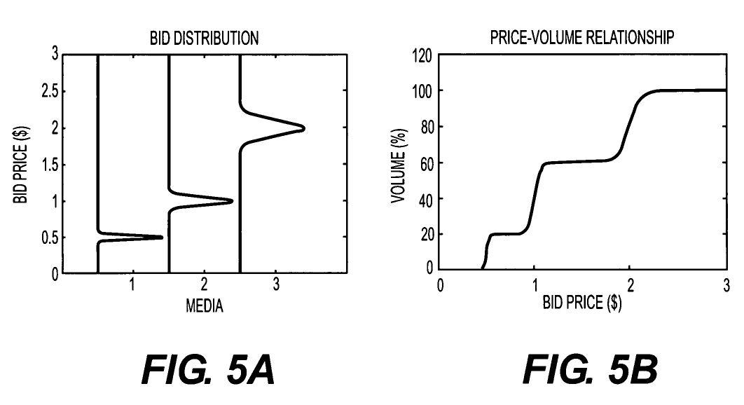

As shown in FIGS. 5A-5B, the exemplary systems and methods described herein may have advantageous effects on bid distribution and price-volume relationships, as compared to that of conventional bidding, which is graphically depicted in FIGS. 4A-4B. FIG. 4A graphically depicts the bid distribution for three exemplary campaigns or “media” using conventional bidding techniques. For example, media 1 may generate ad requests having bid prices of $0.50 and bid allocation of 0.2; media 2 may generate ad requests having bid prices of $1.00 and bid allocation of 0.4; and media 3 may generate ad requests having bid prices of $2.00 and bid allocation of 0.4. As a result, as shown in FIG. 4B, the three media campaigns may generate a price-volume curve which exhibits dramatic steps in price and impression delivery volume. Under such conventional bidding regimes, media 3 will win its $2.00 bids 40% of the time. The system will be subject to instability if high-bidding campaigns withdraw from the system. Moreover, lower bidding campaigns will be unable to reliably expect a certain volume of impression delivery because there exists no single bid price at which a certain volume may be obtained (i.e., the steps at $0.50, $1.00, and $2.00 may be wildly unpredictable, and the bid prices of competing campaigns may be dynamic).

FIG. 5A graphically depicts the bid distribution for three exemplary campaigns or “media” using one or more of the exemplary Heisenberg bidding systems or methods described herein. In this exemplary embodiment, media 1 may generate ad requests having a nominal bid price of $0.50 and bid allocation of 0.2; media 2 may generate ad requests having a nominal bid price of $1.00 and bid allocation of 0.4; and media 3 may generate ad requests having a nominal bid price of $2.00 and bid allocation of 0.4. Using methods consistent with the present invention, the nominal bid prices may be perturbed to create a distribution of final bid prices surrounding the nominal bid prices. Thus, as shown in FIG. 5A, while most of the ad requests may have final bid prices immediately surrounding the respective nominal bid price, there may be a distribution of final bid prices both above and below the nominal bid price. As described above, the value of the final bid price for each ad request may be uncertain, but defined by a probability density function, such as, for example, the Gamma distribution function.

FIG. 5B graphically depicts the price-volume relationship for the three exemplary media campaigns of FIG. 5A. Specifically, because the three media may generate bid prices of varying values, the price-volume relationship may be relatively smoothed, as compared to that of FIG. 4B, where each media bid at a single value of bid price. Because the price-volume relationship may be smoothed, there may exist a single nominal bid price at which a media may bid in order to obtain a desired volume of impression delivery. Moreover, the stability and predictability of the system may be improved, even when competing campaigns are added and withdrawn from the system.

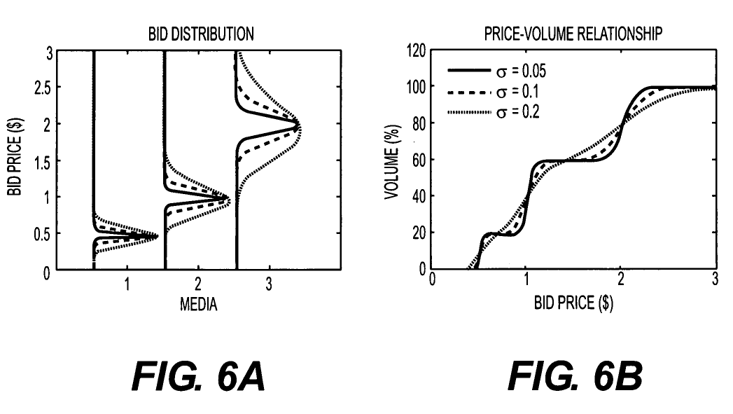

FIGS. 6A and 6B illustrate exemplary effects of varying perturbation parameter values, a, on the bid distribution and price-volume relationship for the exemplary media depicted in FIGS. 5A and 5B. Specifically, FIGS. 6A and 6B illustrate the bid distribution and price-volume relationship, respectively, for bid uncertainties, σ, of 0.05, 0.1, and 0.2. As shown in FIG. 6A, as the perturbation parameter, σ, increases, the distribution of perturbed bid prices, B, may expand and become more distributed away from the nominal bid price, b. As the perturbation parameter, σ, decreases, the distribution of perturbed bid prices, B, may contract and become more focused around the nominal bid price, b. As shown in FIG. 6B, in general, as the perturbation parameter, σ, increases, the price-volume curve may become more smoothed. As the perturbation parameter, σ, decreases, the price-volume curve may be more closely defined by the nominal bid prices of the bidding media. Thus, the perturbation parameter, σ, may be adjusted on the network level, campaign level, media level, site level, and/or slot level, as a powerful tool for adjusting the smoothness of the price-volume relationship of the competing media, even without the use of volume prediction, feedback control, and/or database delivery queries.

In one embodiment, if a campaign is bidding in a system in which the price-volume relationship is already smooth, for example, due to a large number of competing campaigns with a diverse interest in impressions, then the perturbation parameter, σ, may be selected at a value close to zero. In contrast, if the campaign is bidding in a system in which the price-volume relationship is highly stepped and/or unpredictable, the perturbation parameter, σ, may be selected at a relatively high value. In certain embodiments, the perturbation parameter, σ, may be automatically or adaptively adjusted to compensate for perceived characteristics of the advertising system. For example, if adjustment of the nominal bid price does not successfully moderate the impression delivery, the perturbation parameter, σ, may be automatically increased accordingly. In addition, if a campaign has been recently initialized and added to a system, its perturbation parameter, σ, may be set relatively high until its nominal bid price stabilizes to a relatively desirable value.

In one exemplary embodiment, after all of the bids in a bid set for a campaign have been adjusted according to the systems and methods described herein, the bids may be re-sorted in order to minimize the work the ad server 204 must do for each impression transaction. For example, if the originally submitted bid set was already sorted from highest bid price to lowest, it may be expected that the Heisenberg adjustment process may mildly deviate the bids from the originally sorted state. As a result, it may be desirable to select a sort algorithm that performs well when a list is already “mostly sorted.” Furthermore, any set of bids that share identical perturbed bid values may have their relative order randomized each time the bid set is resorted. As a result, the bid set resorting may occur regardless of whether there are any bids that have been adjusted by the Heisenberg adjustment process. Thus, bid sets that have been processed by perturbation engine 206, according to the presently-disclosed methods, may be efficiently matched with impression requests by the market clearing mechanism 208.

While embodiments of these systems and methods have been described with respect to online advertising, the presently disclosed control systems and methods may be used in any system exhibiting relatively discontinuous behavior. For example, these perturbation concepts may be applied to mechanical and electrical systems where it may be useful to slightly deviate an actual control value away from a nominal control value, by a different amount for each time interval or element. In one embodiment, these systems and methods may be applied to mechanical systems subject to friction by sampling over time and perturbing some applied nominal force. In this embodiment, the effective friction coefficient for different applied forces may gracefully transition between the static and dynamic friction coefficient, and therefore provide smooth starting and stopping of the mechanical system. This may provide a more gentle and comfortable ride in trains and cars, for example; and it may offer a refinement to anti-lock brakes. These perturbation concepts may also be applied to electrical systems to improve the behavior of electrical motors. For example, by perturbing some applied nominal current fed into an electrical motor, it may be possible to achieve smooth starting and stopping of the motor. In both of the above examples, unless perturbation techniques are applied, it may be difficult to anticipate what force or current will initiate the system, and the system may suddenly ‘jump’ into motion. On the other hand, when using perturbation concepts similar to those described herein, an operator may detect impending motion as soon as the nominal force/current is sufficiently close to the critical force/current, such that some of the perturbed forces/currents are above their critical values. Thus, the presently disclosed perturbation systems and methods may provide advantageous control of both online advertising campaigns, as well as numerous types of mechanical and electrical systems.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A system for managing bid prices of an online advertising campaign, the system comprising:
a memory storing instructions for adjusting bid prices;
a campaign controller for generating a nominal bid price and a perturbation parameter, based on an ad request received from an advertiser;
an engine for generating a perturbed bid price based on the nominal bid price and the perturbation parameter, according to the instructions stored in the memory; and
a serving unit for serving an ad impression based on the perturbed bid price.

2. The system of claim 1, wherein the campaign controller further generates a bid allocation for the ad request, and the serving unit serves the ad impression based on the perturbed bid price and the bid allocation.

3. The system of claim 1, wherein the engine generates the perturbed bid price based on a probability density function defined by the nominal bid price and the perturbation parameter.

4. The system of claim 3, wherein the probability density function is defined by a Gamma distribution.

5. The system of claim 1, wherein the serving unit for serving the ad impression is a competitive market clearing mechanism configured to match impression requests with ad requests.

6. The system of claim 1, wherein the engine is configured to generate perturbed bid prices independent from the number of advertising campaigns running in an associated advertising network.

7. The system of claim 1, wherein the engine is configured to generate the perturbed bid price using a combination of random and deterministic perturbation functions.

8. The system of claim 1, wherein the perturbed bid price is a function of one or more of the perturbation parameter, the nominal bid price, a bid allocation, a current time, an ad server characteristic, and an ad network characteristic.

9. The system of claim 1, wherein the perturbation parameter is a function of a number of campaigns operating in an advertising network.

10. The system of claim 1, wherein the perturbation parameter is a function of how long the online advertising campaign has been running.

11. A computer-implemented method for managing bid prices of an online advertising campaign, the method comprising:
storing instructions for adjusting bid prices in a memory;
receiving an ad request from an advertiser;
generating a nominal bid price and a perturbation parameter, based on the ad request;
generating a perturbed bid price based on the nominal bid price and the perturbation parameter, according to the instructions stored in the memory; and
serving an ad impression for the ad request based on the perturbed bid price.

12. The computer-implemented method of claim 11, further comprising generating a bid allocation for the ad request and serving the ad impression based on the perturbed bid price and the bid allocation.

13. The computer-implemented method of claim 11, wherein the perturbed bid price is generated based on a probability density function defined by the nominal bid price and the perturbation parameter.

14. The computer-implemented method of claim 13, wherein the probability density function includes a Gamma distributed variable.

15. The computer-implemented method of claim 14, wherein the bid allocation and perturbation parameter implemented by the probability density function are numerical values between 0 and 1, inclusive.

16. The computer-implemented method of claim 11, wherein the perturbed bid price is generated from a Gamma distribution defined by the nominal bid price and the perturbation parameter.

17. The computer-implemented method of claim 16, wherein the Gamma distribution is at least partially defined by a value of the perturbation parameter.

18. The computer-implemented method of claim 11, wherein the method further includes adjusting the perturbation parameter based on characteristics of a network in which the ad impression is served.

19. The computer-implemented method of claim 11, wherein the perturbed bid price is generated based on a probability density function defined by the nominal bid price and the perturbation parameter.

20. The computer-implemented method of claim 11, wherein perturbed bid prices are generated independent from the number of advertising campaigns running in an associated advertising network.

21. The computer-implemented method of claim 11, wherein the perturbed bid price is generated using a combination of random and deterministic perturbation functions.

22. The computer-implemented method of claim 11, wherein the perturbed bid price is a function of one or more of the perturbation parameter, the nominal bid price, a bid allocation, a current time, an ad server characteristic, and an ad network characteristic.

23. The computer-implemented method of claim 11, wherein the perturbation parameter is a function of a number of campaigns operating in an advertising network.

24. The computer-implemented method of claim 11, wherein the perturbation parameter is a function of how long the online advertising campaign has been running.

25. A computer-readable storage medium storing a computer program which, when executed by a computer, causes the computer to perform a method comprising the steps of:
storing instructions for adjusting bid prices in a memory;
receiving an ad request from an advertiser;
generating a nominal bid price and a perturbation parameter, based on the ad request;
generating a perturbed bid price based on the nominal bid price and the perturbation parameter, according to the instructions stored in the memory; and
serving an ad impression for the ad request based on the perturbed bid price.

26. A computer-implemented method for managing bid prices of an online advertising campaign, the method comprising:
storing instructions for adjusting bid prices in a memory;
receiving an ad request from an advertiser;
generating a nominal bid price and one or more bid price adjustment parameters, based on the ad request;
generating an adjusted bid price based on the nominal bid price and one or more bid price adjustment parameters, according to the instructions stored in the memory; and
serving an ad impression for the ad request based on the adjusted bid price.

27. A computer-implemented method for managing bid prices of an online advertising campaign, the method comprising:
storing instructions for adjusting bid prices in a memory;
receiving an ad request from an advertiser;
generating a nominal bid price and a perturbation parameter, based on the ad request;
generating a perturbed bid price based on the nominal bid price and the perturbation parameter, according to the instructions stored in the memory; and
serving an ad impression for the ad request based on the perturbed bid price;
wherein the perturbed bid price B is generated according to
$$B = {b ( σ )}^{2} G ( \frac{1}{{( σ )}^{2}} )$$
where b is the nominal bid price, a is the perturbation parameter, and
$$G ( \frac{1}{{( σ )}^{2}} ) = G ( α ) ,$$
where G(α) is a random number generated from a Gamma distribution with a shape parameter equal to α and scale parameter equal to one.
